(19) United States
(12) Patent Application Publication
(10) Pub. No.: US 2026/0127107 A1
(43) Pub. Date: May 7, 2026

(54) SANDBOX DYNAMIC MEMORY MANAGEMENT

(71) Applicant: Snowflake Inc., Bozeman, MT (US)

(72) Inventors: Brandon S. Baker, Redmond, WA (US); Khushboo Bhatia, Belmont, CA (US); Jiaheng He, Seattle, WA (US); Deen Liu, Redwood City, CA (US); David Ruiz, San Francisco, CA (US); Zihao Ye, Redmond, WA (US)

(21) Appl. No.: 18/938,097

(22) Filed: Nov. 5, 2024

(51) Int. Cl. G06F 12/02

(52) U.S. Cl. CPC G06F 12/023

(57) ABSTRACT

A data platform is provided that collects memory usage data for a function during execution of the function and determines memory constraints of the function during execution using a configurable statistical method and the memory usage data. The data platform dynamically adjusts a memory limit for the function based on the memory constraints and schedules a job including the function using the memory limit without user intervention.

### TECHNICAL FIELD

Examples of the disclosure relate generally to data platforms and, more specifically, to database memory management.

### BACKGROUND

Data platforms are widely used for data storage and data access in computing and communication contexts. With respect to architecture, a data platform can be an on-premises data platform, a network-based data platform (e.g., a cloud-based data platform), a combination of the two, and/or include another type of architecture. With respect to type of data processing, a data platform can implement online transactional processing (OLTP), online analytical processing (OLAP), a combination of the two, and/or another type of data processing. Moreover, a data platform can be or include a relational database management system (RDBMS) and/or one or more other types of database management systems. Cloud-based data platforms may communicate data between databases.

### BRIEF DESCRIPTION OF THE DRAWINGS

The present disclosure will be understood more fully from the detailed description given below and from the accompanying drawings of various examples of the disclosure.

FIG. 1 illustrates an example computing environment that includes a network-based data platform in communication with a cloud storage provider user system, according to some examples.

FIG. 2 is a block diagram illustrating components of a compute service manager, according to some examples.

FIG. 3 is a block diagram illustrating components of an execution platform, according to some examples.

FIG. 4 illustrates a memory optimization method for improving resource allocation in a distributed data processing environment, according to some examples.

FIG. 5 illustrates a diagrammatic representation of a machine in the form of a computer system within which a set of instructions may be executed for causing the machine to perform any one or more of the methodologies discussed herein, according to some examples.

### DETAILED DESCRIPTION

Data platforms are widely used for data storage and data access in computing and communication contexts. These platforms can have various architectures, including on-premises, network-based (e.g., cloud-based), or a combination of both. They can implement different types of data processing, such as online transactional processing (OLTP), online analytical processing (OLAP), or a combination of these. Data platforms often include relational database management systems (RDBMS) and may communicate data between databases. However, as data volumes grow and queries become more complex, optimizing memory allocation becomes increasingly challenging.

Managing and processing large volumes of data in various computing environments presents significant challenges, particularly in memory management. Complex queries and diverse workloads often exacerbate these challenges. Traditional methods for predicting memory usage, such as cardinality estimation, may not effectively address all query types, especially those involving user-defined functions or custom code.

Some existing solutions frequently depend on static memory limits or fixed memory usage values, leading to inefficiencies and potential out-of-memory errors. These issues become more pronounced with the increasing use of large-scale data processing and machine learning tasks. A more dynamic and accurate approach to memory management is desirable to reduce resource contention and enhance the reliability of data processing operations. In some examples, methodologies described herein employ historical memory usage data to estimate future memory constraints for data queries. This approach involves recording memory consumption during previous executions and using this data to inform scheduling decisions. The methodologies include maintaining a set of historical memory statistics and calculating a recommended memory consumption value based on a configurable percentile of these statistics.

In some examples, the methodologies include dynamically adjusting memory limits for data queries based on historical usage data. This can involve increasing the memory ceiling to a significant portion of a node's available memory, allowing queries to utilize more resources when necessary. These methodologies provide for reserving a portion of memory for operating system processes and other functions, ensuring stability while maximizing resource utilization.

In some examples, the methodologies include a process terminator that prioritizes longer-running queries and those already re-tried. The process terminator terminates specific queries under memory pressure to free resources for others, thereby reducing the likelihood of node crashes and improving overall system reliability.

In some examples, a data platform collects memory usage data for a function during execution of the function and determines memory constraints of the function during execution using a configurable statistical method and the memory usage data. The data platform dynamically adjusts a memory limit for the function based on the memory constraints and schedules a job including the function using the memory limit without user intervention.

In some examples, the memory usage data includes, but is not limited to, a maximum memory consumption, an average memory consumption, and memory usage patterns over time. The data platform collects comprehensive memory usage data for each function execution, including metrics such as the peak amount of memory used by the function at any point during its execution (maximum memory consumption), the typical memory usage over the function's runtime (average memory consumption), and how memory consumption fluctuates throughout the function's lifecycle (memory usage patterns over time). This detailed memory usage data allows for analysis and prediction of memory constraints for future executions of the function.

In some examples, the configurable statistical method includes, but is not limited to, a percentile calculation, a moving average, exponential smoothing, or a machine learning-based prediction. The data platform implements various statistical techniques to analyze historical memory usage data and predict future memory constraints for functions. Percentile calculation may be used to determine a specific percentile (e.g., 90th percentile) of historical maximum memory consumption values as the estimated memory constraint. Moving average techniques can calculate an average of memory usage over a specified number of recent executions or a sliding time window, helping to smooth out short-term fluctuations. Exponential smoothing assigns exponentially decreasing weights to older observations, balancing recent changes with historical trends. Machine learning-based prediction models, such as regression models or neural networks, can capture complex relationships between input features and memory consumption, potentially providing more accurate predictions for functions with varying memory constraints.

In some examples, the data platform dynamically adjusts the memory limit raising the memory limit to a configurable percentage of a total instance memory, the percentage determined based on system performance and resource availability.

In some examples, the data platform selectively terminates one or more jobs to free resources when a node of the distributed data processing environment is under memory pressure.

In some examples, scheduling the job comprises determining job placement and resource allocation decisions using the memory limit.

In some examples, the data platform dynamically adjusts a query execution plan for the job based on the memory limit and the current memory conditions of the distributed data processing platform.

In some examples, the data platform adaptively scales resources based on predicted memory needs derived from a workload pattern analysis.

In some examples, applying the configurable statistical method includes determining a function-level memory profile by assigning memory usage into different categories for optimizing memory allocation.

In some examples, scheduling the job comprises distributing two or more jobs across multiple nodes of the distributed data processing environment based on the memory limit.

Reference will now be made in detail to specific examples for carrying out the inventive subject matter. Examples of these specific examples are illustrated in the accompanying drawings, and specific details are set forth in the following description in order to provide a thorough understanding of the subject matter. It will be understood that these examples are not intended to limit the scope of the claims to the illustrated examples. On the contrary, they are intended to cover such alternatives, modifications, and equivalents as may be included within the scope of the disclosure.

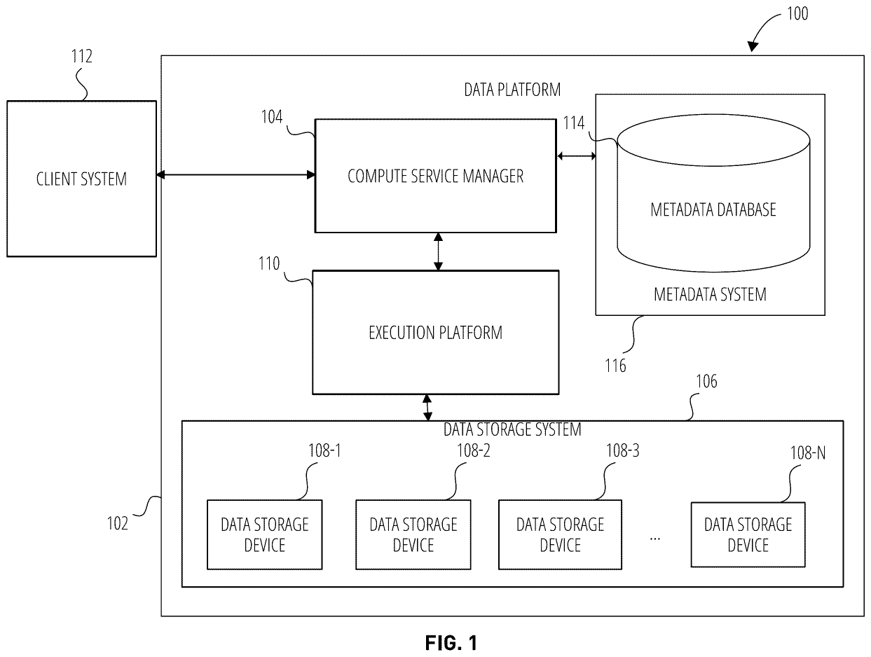

FIG. 1 illustrates an example computing environment 100 that includes a data platform 102 in communication with a client system 112, according to some examples. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a data storage system 106, a compute service manager 104, an execution platform 110, and a metadata system 116. The data storage system 106 comprises a plurality of computing machines and provides on-demand computer system resources such as data storage and computing power to the data platform 102. As shown, the data storage system 106 comprises multiple data storage devices, such as data storage device 108-1, data storage device 108-2, data storage device 108-3, and data storage device 108-N. In some examples, the data storage devices 1 to N are cloud-based storage devices located in one or more geographic locations. For example, the data storage devices 1 to N may be part of a public cloud infrastructure or a private cloud infrastructure. The data storage devices 1 to N may be hard disk drives (HDDs), solid state drives (SSDs), storage clusters, Amazon S3™ storage systems or any other data storage technology. Additionally, the data storage system 106 may include distributed file systems (e.g., Hadoop Distributed File Systems (HDFS)), object storage systems, and the like.

In some examples, one or more of the data storage devices 108-1 to 108-N are cloud-based datastores configured as Virtual Private Clouds (VPCs). In some examples, A VPC is a secure, isolated virtual network within a public cloud environment that allows organizations to run and manage their cloud resources with enhanced control and privacy. A VPC can provide the functionality of a traditional data center without the physical management and maintenance overhead, enabling users to define their own network space. This includes selecting IP address ranges, creating subnets, configuring route tables, and setting up network gateways. VPCs are beneficial for entities that desire a partitioned section of the cloud to ensure that their applications and data are isolated from other users on the same public cloud platform. This isolation helps in maintaining security and compliance with regulatory requirements, while also allowing for scalable and flexible resource management.

In some examples, data objects are stored in structured data files. The structured data files can be in various structured file formats such as, but not limited to, Comma-Separated Values (CSV) JavaScript Object Notation (JSON), Apache Avro (Avro), Apache Parquet (Parquet), Optimized Row Columnar (ORC), Extensible Markup Language (XML), and the like.

In some examples, the data platform 102 organizes data storage using micro-partitions or partitions of a database table using a suitable structured data file format specifically designed for optimal performance and security within the computing environment 100 such as, but not limited to, Flocon De Neige (FDN) and the like. Whenever new data is added to a table, new micro-partition files are created. This approach ensures that data is stored in an immutable format where the addition of a new record results in the generation of a new micro-partition file.

The data platform 102 is used for reporting and analysis of integrated data from one or more disparate sources including the storage devices 1 to N within the data storage system 106. The data platform 102 hosts and provides data reporting and analysis services to multiple consumer accounts. Administrative users can create and manage identities (e.g., users, roles, and groups) and use privileges to allow or deny access to identities to resources and services. Generally, the data platform 102 maintains numerous consumer accounts for numerous respective consumers. The data platform 102 maintains each consumer account in one or more storage devices of the data storage system 106. Moreover, the data platform 102 may maintain metadata associated with the consumer accounts in the metadata database 114 of the metadata system 116. Each consumer account includes multiple objects with examples including users, roles, privileges, a datastores or other data locations.

The compute service manager 104 coordinates and manages operations of the data platform 102. The compute service manager 104 also performs query optimization and compilation as well as managing clusters of compute services that provide compute resources (also referred to as “virtual warehouses”). The compute service manager 104 can support any number and type of clients such as end users providing data storage and retrieval requests, system administrators managing the systems and methods described herein, and other components/devices that interact with compute service manager 104. As an example, the compute service manager 104 is in communication with the client system 112. The client system 112 can be used by a user of one of the multiple consumer accounts supported by the data platform 102 to interact with and utilize the functionality of the data platform 102.

In some examples, the compute service manager 104 does not receive any direct communications from the client system 112 and only receives communications concerning jobs from a queue within the data platform 102.

The compute service manager 104 is also coupled to metadata database metadata system 116. The metadata system 116 includes a metadata database 114 that stores metadata pertaining to various functions and examples associated with the data platform 102 and its users. In some examples, the metadata database 114 includes a summary of data stored in remote data storage systems as well as data available from a local cache. In some examples, the metadata database 114 may include information regarding how data is organized in remote data storage systems (e.g., the data storage system 106) and the local caches. In some examples, the metadata database 114 include data of metrics describing usage and access by provider users and consumers of the data stored on the data platform 102. In some examples, the metadata database 114 allows systems and services to determine whether a piece of data needs to be accessed without loading or accessing the actual data from a storage device.

The compute service manager 104 is further coupled to the execution platform 110, which provides multiple computing resources that execute various data storage and data retrieval tasks. The execution platform 110 is coupled to the data storage system 106. The execution platform 110 comprises a plurality of compute nodes. A set of processes on a compute node executes a query plan compiled by the compute service manager 104. The set of processes can include: a first process to execute the query plan; a second process to monitor and delete micro-partition files using a least recently used (LRU) policy and implement an out of memory (OOM) error mitigation process; a third process that extracts health information from process logs and status to send back to the compute service manager 104; a fourth process to establish communication with the compute service manager 104 after a system boot; and a fifth process to handle communication with a compute cluster for a given job provided by the compute service manager 104 and to communicate information back to the compute service manager 104 and other compute nodes of the execution platform 110.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

As shown in FIG. 1, the data storage devices data storage device 108-1 to data storage device 108-N are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

The compute service manager 104, metadata system 116, execution platform 110, and data storage system 106 are shown in FIG. 1 as individual discrete components. However, each of the compute service manager 104, metadata system 116, execution platform 110, and data storage system 106 may be implemented as a distributed system (e.g., distributed across multiple systems/platforms at multiple geographic locations). Additionally, each of the compute service manager 104, metadata system 116, execution platform 110, and data storage system 106 can be scaled up or down (independently of one another) depending on changes to the requests received and the changing needs of the data platform 102. Thus, in the described examples, the data platform 102 is dynamic and supports regular changes to meet the current data processing needs.

During operation, the data platform 102 processes multiple jobs determined by the compute service manager 104. These jobs are scheduled and managed by the compute service manager 104 to determine when and how to execute the job. For example, the compute service manager 104 may divide the job into multiple discrete tasks and may determine what data is needed to execute each of the multiple discrete tasks. The compute service manager 104 may assign each of the multiple discrete tasks to one or more nodes of the execution platform 110 to process the task. The compute service manager 104 may determine what data is needed to process a task and further determine which nodes within the execution platform 110 are best suited to process the task. Some nodes may have already cached the data needed to process the task and, therefore, be a good candidate for processing the task. Metadata stored in the metadata database 114 assists the compute service manager 104 in determining which nodes in the execution platform 110 have already cached at least a portion of the data needed to process the task. One or more nodes in the execution platform 110 process the task using data cached by the nodes and, if necessary, data retrieved from the data storage system 106. It is desirable to retrieve as much data as possible from caches within the execution platform 110 because the retrieval speed is typically faster than retrieving data from the data storage system 106.

As shown in FIG. 1, the computing environment 100 separates the execution platform 110 from the data storage system 106. In this arrangement, the processing resources and cache resources in the execution platform 110 operate independently of the database storage devices data storage device 108-1 to data storage device 108-N in the data storage system 106. Thus, the computing resources and cache resources are not restricted to a specific one of the data storage device 108-1 to data storage device 108-N. Instead, computing resources and cache resources may retrieve data from, and store data to, any of the data storage resources in the data storage system 106.

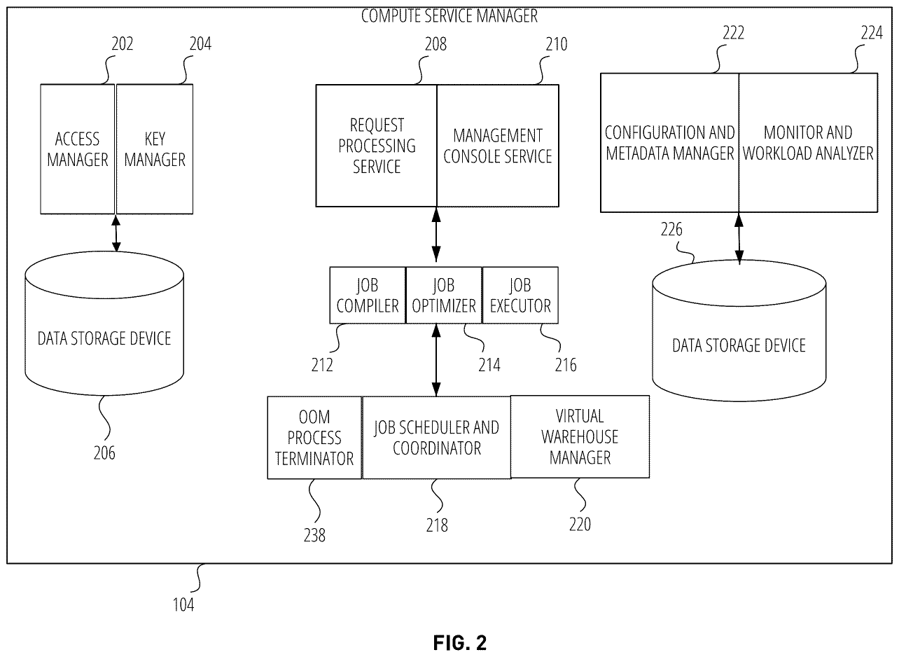

FIG. 2 is a block diagram illustrating components of the compute service manager 104, according to some examples. As shown in FIG. 2, the compute service manager 104 includes an access manager 202, and a key manager 204. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage data storage device 206). As used herein, the remote storage devices may also be referred to as “persistent storage devices” or “shared storage devices.”

In some examples, the access manager 202 operates within a data platform to control access to various objects of the data platform using Role-Based Access Control (RBAC). The access manager 202 is a component that manages authentication and authorization tasks, providing for authorized entities to access specific resources within the data platform. This component plays a role in maintaining the security and integrity of the data platform by enforcing access policies defined through RBAC.

In some examples, RBAC is implemented by defining roles within the data platform, where each role is associated with a specific set of permissions. These permissions determine the actions that entities assigned to the role can perform on various objects within the data platform. The access manager 202 utilizes these roles to make access control decisions, allowing or denying requests based on the roles assigned to the requesting entity and the permissions associated with those roles.

In some examples, the data platform creates specific access roles based on a manifest of an application received from an application package. These access roles are activated by the access manager 202 and are used to govern access to objects used by the application during operation. For example, an access role may grant the application the ability to create a compute pool and execute a service within that compute pool. The access manager 202 provides that an application, or entities authorized by the application, can perform actions permitted by the access role.

In some examples, the access manager 202 also controls access to objects of the data platform using the access roles during the execution of the service within the compute pool. The service accesses objects of the application package and of the data platform under the governance of the activated access roles. The access manager 202 checks the permissions associated with the access roles against the access requests made by the service, granting or denying these requests based on the defined RBAC policies.

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage system 106.

A management console service 210 supports access to various systems and processes by administrators and other system managers. Additionally, the management console service 210 may receive a request to execute a job and monitor the workload on the system.

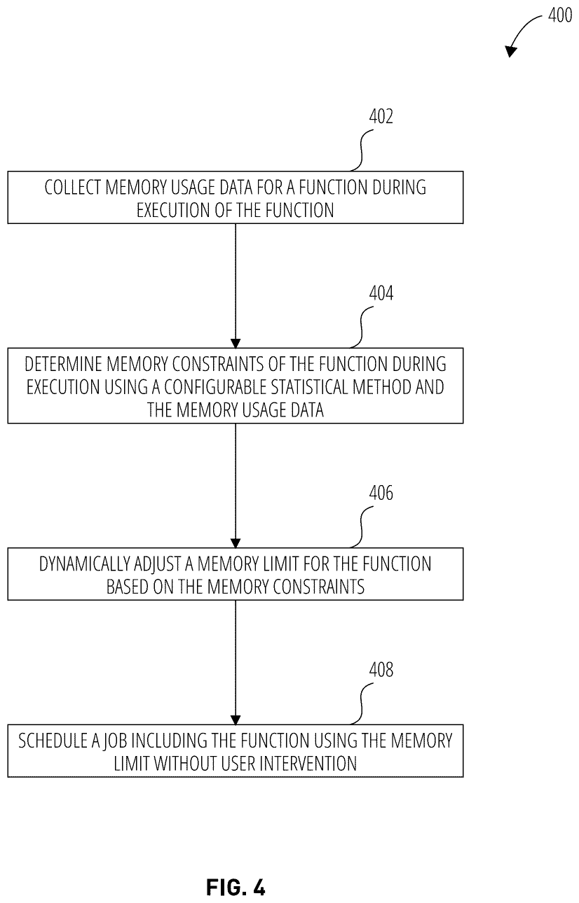

The compute service manager 104 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. In some examples, the job optimizer 214 adaptively scales resources based on predicted memory needs derived from a workload pattern analysis as more fully described in reference to FIG. 4.

The job executor 216 is a component of the compute service manager 104 that executes the execution code for jobs received from a queue or determined by the compute service manager. It works in conjunction with other components like the job compiler 212 and job optimizer 214 to process jobs within the data platform. The job executor 216 is responsible for carrying out the actual execution of compiled and optimized jobs, utilizing the resources of the execution platform 110 to perform data storage and retrieval tasks.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 determines a priority for internal jobs that are scheduled by the compute service manager 104 with other “outside” jobs such as user queries that may be scheduled by other systems in the database but may utilize the same processing resources in the execution platform 110. In some examples, the job scheduler and coordinator 218 identifies or assigns particular nodes in the execution platform 110 to process particular tasks. A virtual warehouse manager 220 manages the operation of multiple virtual warehouses implemented in the execution platform 110. As discussed below, each virtual warehouse includes multiple execution nodes that each include a cache and a processor.

In some examples, the job scheduler and coordinator 218 takes into account dynamically adjusted memory limits for each function included in a job. The job scheduler and coordinator 218 uses the memory constraints as a parameter when determining which execution nodes or virtual warehouses are best suited to process a particular job. The job scheduler and coordinator 218 may consider factors such as available memory on different nodes, current workload distribution, and potential resource contention when making placement decisions as more fully described in reference to FIG. 4.

In some examples, the compute service manager 104 includes an Out Of Memory (OOM) process terminator 238. The OOM process terminator 238 monitors memory usage across an execution node and takes action when memory pressure is detected as more fully described in reference to FIG. 4.

Additionally, the compute service manager 104 includes a configuration and metadata manager 222, which manages the information related to the data stored in the remote data storage devices and in the local caches (e.g., the caches in execution platform 110). The configuration and metadata manager 222 uses the metadata to determine which data micro-partitions need to be accessed to retrieve data for processing a particular task or job. A monitor and workload analyzer 224 oversees processes performed by the compute service manager 104 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 in FIG. 2 represents any data storage device within the data platform 102. For example, data storage device 226 may represent caches in execution platform 110, storage devices in data storage system 106, or any other storage device.

The compute service manager 104 validates communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 304a) may need to communicate with another execution node (e.g., execution node 304b), and should be disallowed from communicating with a third execution node (e.g., execution node 316a) and any such illicit communication can be recorded (e.g., in a log or other location). Also, the information stored on a given execution node is restricted to data relevant to the current query and any other data is unusable, rendered so by destruction or encryption where the key is unavailable.

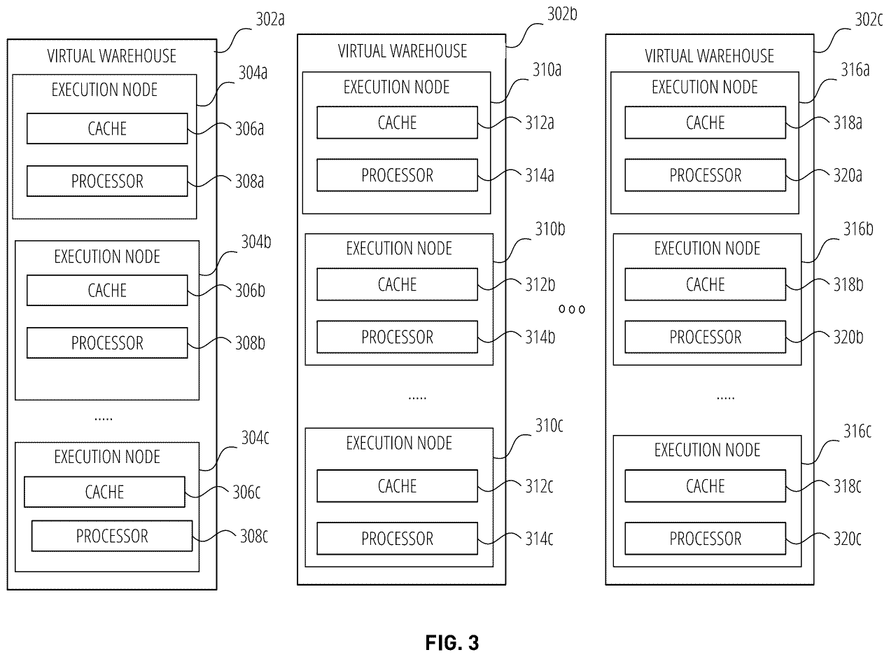

FIG. 3 is a block diagram illustrating components of the execution platform 110, according to some examples. As shown in FIG. 3, the execution platform 110 includes multiple virtual warehouses, including virtual warehouse 302a, and virtual warehouse 302b to virtual warehouse 302c. Each virtual warehouse includes multiple execution nodes that each includes a data cache and a processor. The virtual warehouses can execute multiple tasks in parallel by using the multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. Virtual warehouses can access data from any data storage device (e.g., any storage device in data storage system 106).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 1 to N shown in FIG. 1. Thus, the virtual warehouses are not necessarily assigned to a specific data storage device 1 to N and, instead, can access data from any of the data storage devices 1 to N within the data storage system 106. Similarly, each of the execution nodes shown in FIG. 3 can access data from any of the data storage devices 1 to N. In some examples, a particular virtual warehouse or a particular execution node may be temporarily assigned to a specific data storage device, but the virtual warehouse or execution node may later access data from any other data storage device.

In the example of FIG. 3, virtual warehouse 302a includes a plurality of execution nodes as exemplified by execution node 304a, execution node 304b, and execution node 304c. Execution node 304a includes cache 306a and a processor 308a. Execution node 304b includes cache 306b and processor 308b. Execution node 304c includes cache 306c and processor 308c. Each execution node 1 to N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 302a discussed above, virtual warehouse 302b includes a plurality of execution nodes as exemplified by execution node 310a, execution node 310b, and execution node 310c. Execution node 304a includes cache 312a and processor 314a. Execution node 310b includes cache 312b and processor 314b. Execution node 310c includes cache 312c and processor 314c. Additionally, virtual warehouse 302c includes a plurality of execution nodes as exemplified by execution node 316a, execution node 316b, and execution node 316c. Execution node 316a includes cache 318a and processor 320a. Execution node 316b includes cache 318b and processor 320b. Execution node 316c includes cache 318c and processor 320c.

In some examples, the execution nodes shown in FIG. 3 are stateless with respect to the data the execution nodes are caching. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate examples may include execution nodes containing any number of processors and any number of caches. Additionally, the caches may vary in size among the different execution nodes. The caches shown in FIG. 3 store, in the local execution node, data that was retrieved from one or more data storage devices in data storage system 106. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some examples, the caches are implemented using high-speed memory devices that provide fast access to the cached data. Each cache can store data from any of the storage devices in the data storage system 106.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some examples, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some examples, these different computing systems are cloud-based computing systems maintained by one or more different entities.

Additionally, each virtual warehouse as shown in FIG. 3 has multiple execution nodes. The multiple execution nodes associated with each virtual warehouse may be implemented using multiple computing systems at multiple geographic locations. For example, an instance of virtual warehouse 302a implements execution node 304a and execution node 304b on one computing platform at a geographic location and implements execution node 304c at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some examples, the virtual warehouses may operate on the same data in data storage system 106, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

FIG. 4 illustrates an example memory optimization method 400, according to some examples. Although the example memory optimization method 400 depicts a particular sequence of operations, the sequence may be altered without departing from the scope of the present disclosure. For example, some of the operations depicted may be performed in parallel or in a different sequence that does not materially affect the function of the memory optimization method 400. In other examples, different components of a data platform 102 (of FIG. 1) that implements the memory optimization method 400 may perform functions at substantially the same time or in a specific sequence.

The memory optimization method is implemented in a sandbox environment that is an isolated and controlled execution environment within the data platform 102 that runs user-provided custom code (such as Python, Java, or Scala) for User-Defined Functions (UDFs), User-Defined Table Functions (UDTFs), User-Defined Aggregate Functions (UDAFs), and stored procedures. The sandbox enforces memory limits and resource constraints to ensure the safe and efficient execution of user code within the larger data platform environment.

In some examples, the sandbox environment includes memory management, where the sandbox implements dynamic memory limits to control resource consumption by user code. By doing so, the sandbox environment provides a secure and isolated space for executing custom code, separate from the core system processes. The sandbox allows for dynamic adjustment of memory limits based on historical usage data and current system conditions. By managing resources within the sandbox, the system aims to improve overall query performance and reduce out-of-memory errors. The sandbox concept applies across different warehouse types of the data platform 102.

In operation 402, a compute service manager 104 (of FIG. 1) collects memory usage data for a function during execution of the function. For example, collecting the memory usage data can include tracking and recording various metrics related to memory consumption as the function runs.

In some examples, the memory usage data collected by the compute service manager 104 includes comprehensive metrics that provide insights into the function's memory consumption patterns. This memory usage data encompasses various aspects of memory utilization during the function's execution. In some examples, the memory usage data includes maximum memory consumption, which represents the peak amount of memory used by the function at any point during its execution. Additionally, the memory usage data can capture average memory consumption, providing a measure of the typical memory usage over the function's runtime. The memory usage data can include memory usage patterns over time, which offer a detailed view of how memory consumption fluctuates throughout the function's lifecycle.

In additional examples, the memory usage data may incorporate more granular metrics such as memory allocation and deallocation events, memory fragmentation patterns, and garbage collection cycles. The compute service manager 104 can also record contextual information like input data size and execution time to provide a comprehensive understanding of memory usage in relation to workload characteristics. This detailed memory usage data allows for analysis and prediction of memory constraints for future executions of the function.

In some examples, the compute service manager implements a tracking system to track memory usage over time. This tracking system records comprehensive data points such as maximum memory consumption, average memory consumption, and memory usage patterns over time for each function execution. The collected data is stored in a structured format that allows for efficient retrieval and analysis.

In some examples, the tracking system implements a comprehensive monitoring framework that collects various execution metrics beyond memory consumption. The tracking system tracks CPU usage statistics, per-row execution time measurements, overall function execution duration, external file read sizes from previous executions, and the like. This collected historical data is stored in a metadata database and used by the compute service manager to optimize subsequent runs of functions and queries.

In additional examples, the compute service manager employs data collection techniques to capture granular memory usage information. This may include recording memory allocation and deallocation events, tracking memory fragmentation, monitoring garbage collection cycles, and measuring peak memory usage at different stages of function execution. The system may also capture contextual information such as input data size, execution time, and concurrent workload conditions to provide a more comprehensive view of memory usage patterns.

In operation 404, the compute service manager 104 determines memory constraints of the function during execution using a configurable statistical method and the memory usage data. For example, this process can include analyzing the collected historical memory usage data to generate recommended memory consumption values for functions.

In some examples, the compute service manager 104 applies a configurable statistical method to the memory usage data to predict future memory constraints. This method may include techniques such as percentile calculation, moving average, exponential smoothing, or machine learning-based prediction.

In some examples, the compute service manager 104 can collect and store historical memory usage data for each function execution. For example, it may keep track of the maximum memory consumption for the last K (e.g., 10) executions of a particular function. To estimate future memory constraints, the compute service manager 104 calculates a specific percentile (e.g., 90th percentile) of these historical maximum memory consumption values. For instance, if a function has the following historical maximum memory usage values (in MB): 100, 120, 110, 130, 105, 115, 125, 135, 140, 150, and the system is configured to use the 90th percentile, the compute service manager 104 sorts these values and select the 9th value (135 MB) as the estimated memory constraint for future executions. This approach provides a conservative estimate that accounts for typical memory usage patterns while allowing for some variability. The percentile value can be adjusted based on the specific needs of the system and workload characteristics. Using this method, the system can make more informed scheduling decisions and reduce the likelihood of out-of-memory errors without over-allocating resources.

In some examples, the compute service manager 104 continuously collects memory usage data for each function execution over time. The use of exponential smoothing assigns exponentially decreasing weights to older observations, giving more importance to recent memory usage data while still considering historical trends. For example, the system might use a smoothing factor α (alpha) between 0 and 1 to calculate the smoothed memory estimate. An example formula for simple exponential smoothing is:

$$St = α * Yt + ( 1 - α ) * St - 1$$

Where:
St is the smoothed estimate for time t.
Yt is the actual observed value at time t.
St-1 is the previous smoothed estimate a is the smoothing factor.

A higher a value gives more weight to recent observations, making the estimate more responsive to changes. A lower a results in a more stable estimate that changes more slowly. This approach can provide a balance between adapting to recent changes in memory usage patterns and maintaining some stability based on historical data.

In some examples, the compute service manager 104 continuously collects memory usage data for each function execution over time and uses a sliding window process. Instead of using just the maximum memory consumption, the compute service manager 104 calculates an average of the memory usage over a specified number of recent executions or a sliding time window. For example, the system might maintain a sliding window of the last N (e.g., 10) executions of a function. Each time the function is executed, the system adds the new memory usage data point to the window and removes the oldest one. The average of these N data points are used as the estimated memory constraint for future executions. This approach can help smooth out short-term fluctuations in memory usage and provide a more stable estimate over time. The size of the sliding moving average window can be adjusted based on the specific needs of the system and the characteristics of the workload. A larger sliding window provides more stability but might be slower to adapt to changes, while a smaller window is more responsive to recent trends but potentially more volatile. In some examples, the moving average can be weighted to give more importance to recent executions, allowing the compute service manager 104 to adapt more quickly to changing memory usage patterns while still considering historical data. This weighted moving average can be particularly useful for functions with evolving memory constraints or those that process data sets of varying sizes.

In some examples, the compute service manager 104 uses a machine learning model to perform the functions of a configurable statistical method for memory usage estimation. For example, the compute service manager 104 can collect comprehensive memory usage data for each function execution over time, including features such as input data size, execution time, and actual memory consumption. This historical data serves as the training dataset for the machine learning model. The machine learning model can be implemented as a supervised learning algorithm, such as a regression model or a neural network, that takes various input features (e.g., function ID, input data characteristics, execution context) and predicts the expected memory usage for a given function execution. During the training phase, the machine learning model learns patterns and relationships between the input features and the actual memory consumption. This allows the machine learning model to capture complex dependencies that may not be easily expressed through simple statistical methods. Once trained, the machine learning model is integrated into the compute service manager 104 as part of its configurable statistical method for determining memory constraints. When a function is about to be executed, the machine learning model takes the relevant input features and provides a prediction of the expected memory usage.

In some examples, the compute service manager 104 implements an online learning approach, where the machine learning model is continuously updated with new execution data. This allows the machine learning model to adapt to changing patterns in memory usage over time and improve its predictions as more data becomes available. Accordingly, a machine learning model can capture more complex relationships and provide more accurate predictions than simpler statistical methods, especially for functions with varying memory constraints based on input data or execution context. Several types of machine learning models can be used for performing the functions of a configurable statistical method in the context of memory usage estimation and optimization. These include linear regression, decision trees, random forests, gradient boosting machines, support vector machines, neural networks, K-nearest neighbors, Bayesian models, time series models (such as ARIMA or Prophet), and ensemble methods. These models can analyze historical memory usage data and predict future memory constraints for functions, enabling more accurate and dynamic memory allocation in the distributed data processing environment.

In some examples, the compute service manager 104 calculates a recommended memory consumption value based on a configurable percentile of the historical memory statistics.

In additional examples, the compute service manager 104 analyzes memory usage patterns and predicts future requirements. This analysis can consider factors such as input data size, execution time, and concurrent workload conditions. In some examples, the compute service manager 104 system can use machine learning models trained on historical data to make more accurate predictions, adapting to changing workload characteristics over time. The configurable nature of the statistical method allows for fine-tuning based on specific workload patterns and system requirements, enabling the compute service manager 104 to optimize memory allocation across various types of functions and workloads.

In some examples, applying a configurable statistical method includes determining a function-level memory profile by assigning memory usage into different categories for optimizing memory allocation. This process involves analyzing the collected memory usage data to create a detailed profile of how the function utilizes memory resources.

In some examples, the compute service manager 104 categorizes memory usage based on factors such as maximum memory consumption, average memory consumption, and memory usage patterns over time. These categories provide a comprehensive view of the function's memory behavior, allowing for more precise allocation and optimization strategies.

In additional examples, the compute service manager 104 may implement more granular categorization, such as distinguishing between short-term and long-term memory allocations, identifying memory usage spikes, and classifying memory usage based on different stages of function execution. The system may also consider factors like input data size, execution time, and concurrent workload conditions when creating the function-level memory profile.

This detailed categorization enables the system to make more informed decisions about memory allocation, potentially improving overall system performance and resource utilization.

In some examples, the compute service manager 104 collects and analyzes memory usage data along with related factors that can affect memory scaling. The compute service manager 104 tracks input data characteristics such as, but not limited to, table sizes, data scanned, external data read sizes during function execution, and the like. This comprehensive data collection enables the compute service manager 104 to understand how memory requirements scale with different input parameters.

In some examples, the compute service manager 104 records metrics including the size of result sets, external data read sizes, network data transfer volumes, and the like to establish correlations between these factors and memory consumption patterns. The compute service manager 104 stores these metrics alongside memory usage statistics in the metadata database to inform future scheduling decisions.

In additional examples, the compute service manager 104 captures granular information about how memory usage scales with different input characteristics. This includes tracking memory allocation patterns based on input table partitioning, monitoring memory consumption relative to external file sizes being processed, analyzing memory usage trends across different network data transfer volumes, and the like. The compute service manager 104 uses this detailed scaling information to make more accurate predictions about memory requirements for future executions with similar input characteristics.

In some examples, the compute service manager 104 collects and analyzes historical CPU consumption data and execution time metrics to optimize scheduling decisions. The compute service manager 104 tracks CPU utilization patterns and execution duration statistics for functions during their execution, storing this information alongside memory usage data in a metadata database.

In some examples, the compute service manager 104 records detailed metrics about CPU usage, including per-row execution time measurements, overall function execution duration, and the like. The compute service manager 104 uses these metrics to establish patterns between CPU consumption, execution time, and workload characteristics to inform future scheduling decisions.

In additional examples, the compute service manager 104 captures more granular information about CPU utilization and execution timing. This includes tracking CPU usage patterns across different stages of function execution, monitoring execution time variations based on input characteristics, analyzing relationships between CPU consumption and execution duration, and the like.

In some examples, compute service manager 104 implements adaptive resource scaling by analyzing workload characteristics and system metrics to select optimal instance types for executing jobs. The system considers factors like memory requirements, CPU utilization, and execution patterns to match workloads with cost-effective computing resources.

In some examples, the compute service manager 104 uses historical usage data and performance metrics to determine the most suitable instance type for a given workload. The compute service manager 104 evaluates memory consumption patterns, CPU utilization trends, and execution time statistics to make informed decisions about resource allocation and instance selection.

In additional examples, the compute service manager 104 implements instance selection processes that consider multiple dimensions of resource utilization as they relate to cost efficiency. This includes analyzing memory scaling patterns with input data sizes, monitoring CPU usage across different execution phases, and tracking execution time variations to identify optimal instance types. The compute service manager 104 dynamically adjusts instance selection based on changing workload characteristics while maintaining performance requirements and cost efficiency.

In operation 406, the compute service manager 104 dynamically adjusts a memory limit for the function based on the memory constraints. This process can include modifying the allocated memory resources in real-time to optimize performance and resource utilization.

In some examples, the compute service manager 104 implements a dynamic memory limit adjustment mechanism. This mechanism raises the memory limit to a configurable percentage of a total instance memory, with the percentage determined based on system performance and resource availability. As an example, the compute service manager 104 may set the configurable percentage to approximately 80% of the total instance memory, allowing for efficient use of available resources while maintaining a buffer for system processes.

In additional examples, the compute service manager 104 continuously monitors and adjusts memory limits during function execution. This process can consider factors such as current memory usage, predicted future requirements, and overall system load. In some examples, the compute service manager 104 can implement intelligent memory compression and swapping techniques, compressing or swapping less frequently accessed data to disk to free up memory for active computations. In some examples, the compute service manager 104 can dynamically adjust query execution plans based on current memory conditions, choosing different join algorithms or adjusting the degree of parallelism to optimize performance within available resources.

In operation 408, the compute service manager 104 schedules a job including the function using the memory limit without user intervention. For example, this process can include utilizing the adjusted memory limits as a factor in making job placement and resource allocation decisions.

In some examples, the compute service manager 104 implements a job scheduler and coordinator 218 (of FIG. 2) that takes into account the dynamically adjusted memory limits for each function. The job scheduler and coordinator 218 uses the memory constraints as a parameter when determining which execution nodes or virtual warehouses are best suited to process a particular job. The job scheduler and coordinator 218 may consider factors such as available memory on different nodes, current workload distribution, and potential resource contention when making placement decisions.

In additional examples, the job scheduler and coordinator 218 optimizes job scheduling across the distributed data processing environment. The job scheduler and coordinator 218 can consider multiple dimensions beyond just memory usage, such as CPU utilization, data locality, and network bandwidth. In some examples, the job scheduler and coordinator 218 can implement predictive scheduling techniques, using historical performance data and current system state to anticipate resource needs and preemptively allocate resources. In some examples, the job scheduler and coordinator 218 may dynamically adjust its decisions in real-time based on changing workload patterns and system conditions, ensuring efficient resource utilization without requiring manual intervention from users or administrators.

In some examples, scheduling the job includes using the memory limit as a factor in making the job placement and resource allocation decisions. The job scheduler and coordinator 218 implements an intelligent scheduling system that takes into account the dynamically adjusted memory limits for each function when determining which execution nodes or virtual warehouses are best suited to process a particular job. This job scheduler and coordinator 218 considers factors such as available memory on different nodes, current workload distribution, and potential resource contention when making placement decisions. By utilizing the memory limit as a parameter, the scheduler can more effectively distribute jobs across the distributed data processing environment, optimizing resource utilization and reducing the likelihood of memory-related issues during job execution.

In some examples, the compute service manager 104 utilizes the dynamically adjusted memory limit for each function to make informed scheduling decisions. When a job including the function needs to be scheduled, the job scheduler and coordinator 218 considers the memory constraints alongside other factors such as available resources on different nodes, current workload distribution, and potential resource contention. In some examples, the job scheduler and coordinator 218 within the compute service manager 104 takes into account the memory limit when determining which execution nodes or virtual warehouses are best suited to process the job. The job scheduler and coordinator 218 evaluates the available memory on different nodes against the memory limit of the function to find an optimal placement that minimizes the risk of out-of-memory errors while efficiently utilizing resources.

For example, if a function has a memory limit of 1 GB, the job scheduler and coordinator 218 can prioritize placing the job on a node with at least 1 GB of free memory, or the job scheduler and coordinator 218 might choose to distribute the workload across multiple nodes if a single node cannot accommodate the full memory constraint. In some examples, the job scheduler and coordinator 218 may also consider factors such as data locality and network bandwidth when making these placement decisions. In some examples, the job scheduler and coordinator 218 uses the memory limit to determine the degree of parallelism for the job execution. The job scheduler and coordinator 218 may adjust the number of parallel tasks based on the available memory across the execution platform 110, ensuring that each task has sufficient memory to operate within the specified limit. By leveraging the dynamically adjusted memory limits, the job scheduler and coordinator 218 can make more accurate and efficient scheduling decisions, potentially reducing the likelihood of out-of-memory errors and improving overall resource utilization without requiring manual intervention from users.

In some examples, the job scheduler and coordinator 218 dynamically adjusts a query execution plan for the job based on the memory limit and the current memory conditions of the distributed data processing platform. This process involves modifying the execution strategy of the query to optimize performance within the available memory constraints.

In some examples, the job scheduler and coordinator 218 implements an adaptive query execution mechanism that considers both the dynamically adjusted memory limits and the real-time memory conditions of the distributed data processing platform. This mechanism may adjust various aspects of the query execution plan, such as join algorithms, degree of parallelism, or data partitioning strategies, to ensure efficient execution within the available memory resources.

In additional examples, the compute service manager 104 continuously monitors memory usage and adjusts the query execution plan in real-time. The compute service manager 104 can consider factors such as current memory utilization, predicted memory constraints for different execution stages, and overall system load. In some examples, the compute service manager 104 may implement techniques such as dynamic repartitioning of data, adaptive spilling to disk, or on-the-fly adjustment of execution parallelism to optimize query performance while respecting memory constraints.

In some examples, the compute service manager 104 implements predictive scaling based on memory usage patterns and out-of-memory events. The compute service manager 104 analyzes historical memory consumption data and OOM incidents to proactively adjust warehouse resources before memory exhaustion occurs.

In some examples, the compute service manager 104 uses memory usage statistics and OOM events to trigger automatic scaling of warehouse resources. When the job detects memory pressure or receives OOM signals, it can dynamically increase the warehouse size or adjust the instance type to better accommodate the workload's memory requirements.

In additional examples, the compute service manager 104 implements scaling algorithms that consider multiple factors including historical memory usage patterns, previous OOM events, and predicted memory requirements. The compute service manager 104 can analyze patterns of memory exhaustion across different workload types and automatically scale up warehouse resources by selecting larger instance types or adding nodes to prevent future OOM occurrences. The compute service manager 104 continuously monitors memory utilization trends and OOM events to optimize the scaling decisions.

As an example, the computer service manager 104 supports standard warehouses and optimized warehouses. For standard warehouses, users typically can not use all available execution node memory due to static memory limits, while optimized customers can only use ⅓rd of available memory by default unless they set a user configuration parameter setting a maximum level. Memory limits vary by warehouse type with standard warehouses being allocated 5 GB for Python, 7 GB for Java/Scala with 16-32 GB total available memory per node. For optimized warehouses, 80 GB is a default limit that can be increased to 150 GB or 230 GB based on a configuration parameter with 256 GB total available memory per node. Through the use of dynamic memory allocation, the compute service manager 104 implements warehouse scheduling improvements through a Warehouse Scheduling Service (WSS), which moderates work assigned to execution nodes. WSS makes scheduling decisions based on memory estimation and CPU requirements. The WSS assumes jobs are evenly distributed among servers and makes scheduling decisions before jobs execute. For warehouse optimization, the compute service manager 104 collects historical usage data including memory consumption, CPU usage, and execution times to improve scheduling decisions. This helps reduce out-of-memory errors and resource contention across warehouse nodes. In some examples, the computer service manager 104 supports multi-cluster warehouse modes and can automatically scale warehouse resources based on memory pressure and OOM events. When memory pressure is detected, it can dynamically adjust warehouse size or instance types to better handle workload requirements.

In some examples, a job optimizer 214 adaptively scales resources based on predicted memory needs derived from a workload pattern analysis. For example, the job optimizer 214 implements an adaptive resource scaling mechanism that analyzes historical workload patterns to predict future memory constraints. This mechanism may consider factors such as input data size, execution time, and concurrent workload conditions to forecast memory needs for different types of functions and queries. The job optimizer 214 may use machine learning models trained on historical data to make more accurate predictions, adapting to changing workload characteristics over time.

In additional examples, the job optimizer 214 continuously monitors workload patterns and adjusts resource allocation in real-time. The job optimizer 214 may consider multiple dimensions beyond just memory usage, such as CPU utilization, data locality, and network bandwidth. The system may implement predictive scaling techniques, proactively allocating or deallocating resources based on anticipated demand. In additional examples, the job optimizer 214 may dynamically adjust the size and composition of virtual warehouses or execution clusters to optimize performance and cost-efficiency for varying workload intensities and patterns.

In some examples, scheduling a job includes distributing two or more jobs across multiple nodes of the distributed data processing environment based on the memory limit. This process involves the job scheduler and coordinator 218 utilizing the dynamically adjusted memory limits to make informed decisions about job placement and resource allocation across the available nodes in the execution platform 110. In some examples, the job scheduler and coordinator 218 implements an intelligent scheduling process that considers the memory constraints of each job alongside other factors such as available resources on different nodes, current workload distribution, and potential resource contention. This approach allows for more efficient utilization of the distributed computing resources, potentially reducing the likelihood of memory-related issues during job execution.

In additional examples, the job scheduler and coordinator 218 may employ techniques such as load balancing and predictive analytics to optimize job distribution. The job scheduler and coordinator 218 may consider historical performance data, anticipated memory usage patterns, and real-time system metrics to make more accurate placement decisions. The job scheduler and coordinator 218 may also dynamically adjust the distribution of jobs across nodes in response to changing workload characteristics or system conditions, ensuring optimal resource utilization and minimizing the risk of memory-related failures.

In some examples, the job scheduler and coordinator 218 selectively terminates one or more jobs to free resources when a node of the distributed data processing environment is under memory pressure. This process involves identifying and terminating specific jobs to alleviate memory constraints and prevent system-wide issues.

In some examples, the job scheduler and coordinator 218 implements an Out-of-Memory (OOM) process terminator that runs as a background process on all warehouse nodes. This OOM process terminator monitors memory usage across the node and takes action when memory pressure is detected. For example, The OOM process terminator continuously tracks memory consumption across all nodes in the warehouse. Configurable thresholds for memory pressure are defined, such as a percentage of total available memory. Historical memory usage statistics for functions and queries are stored in a metadata database. The OOM process terminator compares current memory usage against historical data and defined thresholds. When memory usage exceeds thresholds or shows abnormal patterns compared to historical data, a memory pressure event is identified.

In some examples, the OOM process terminator uses a prioritization algorithm to determine which jobs to terminate, considering factors such as job runtime and retry status. In some examples, OOM process terminator prioritizes longer-running queries and those that are already being retried. This approach allows the OOM process terminator to preserve jobs that have invested more time and resources, potentially reducing overall resource waste.

In some examples, when memory pressure is detected, the OOM process terminator identifies specific queries to terminate, freeing up resources for other jobs to continue execution. This selective termination helps prevent system-wide issues such as node crashes, which could impact all running queries on the server. By terminating specific jobs before the entire node becomes unstable, the OOM killer improves overall system reliability and reduces the likelihood of cascading failures that could affect multiple queries. This approach allows the system to maintain stability while maximizing resource utilization in the distributed data processing environment.

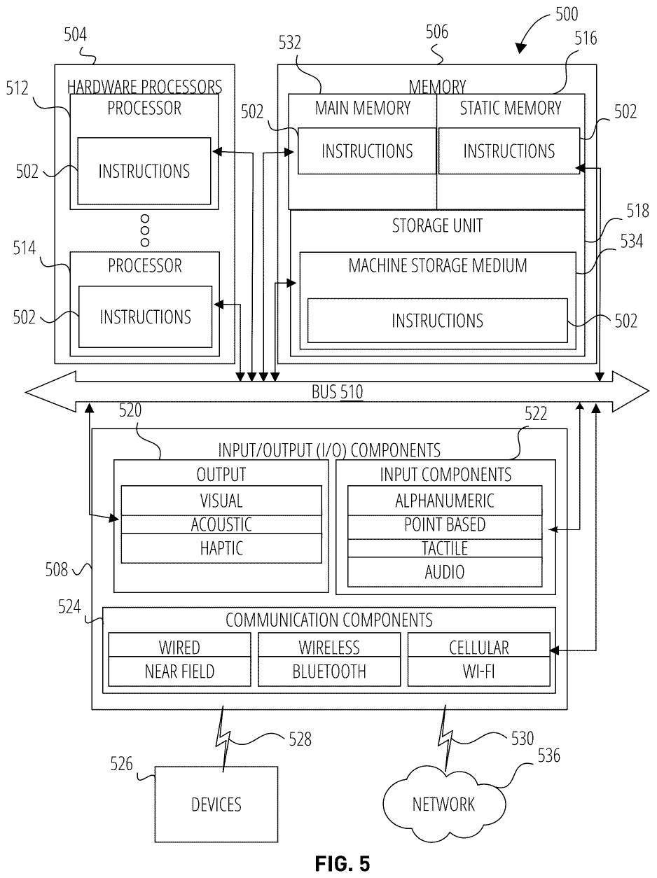

FIG. 5 illustrates a diagrammatic representation of a machine 500 in the form of a computer system within which a set of instructions may be executed for causing the machine 500 to perform any one or more of the methodologies discussed herein, according to examples. Specifically, FIG. 5 shows a diagrammatic representation of the machine 500 in the example form of a computer system, within which instructions 502 (e.g., software, a program, an application, an applet, an application, or other executable code) for causing the machine 500 to perform any one or more of the methodologies discussed herein may be executed. For example, the instructions 502 may cause the machine 500 to execute any one or more operations of any one or more of the methods described herein. In this way, the instructions 502 transform a general, non-programmed machine into a particular machine 500 (e.g., the compute service manager 104, the execution platform 110, and the data storage devices 108-1 to 108-N of data storage system 106) that is specially configured to carry out any one of the described and illustrated functions in the manner described herein.

In alternative examples, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 502, sequentially or otherwise, that specify actions to be taken by the machine 500. Further, while only a single machine 500 is illustrated, the term “machine” shall also be taken to include a collection of machines that individually or jointly execute the instructions 502 to perform any one or more of the methodologies discussed herein.

The machine 500 includes hardware processors 504, memory 506, and I/O components 508 configured to communicate with each other such as via a bus 510. In some examples, the hardware processors 504 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another hardware processor, or any suitable combination thereof) may include, for example, multiple processors as exemplified by processor 512 and a processor 514 that may execute the instructions 502. The term “processor” is intended to include multi-core processors that may comprise two or more independent processors (sometimes referred to as “cores”) that may execute instructions 502 contemporaneously. Although FIG. 5 shows multiple hardware processors 504, the machine 500 may include a single processor with a single core, a single processor with multiple cores (e.g., a multi-core processor), multiple processors with a single core, multiple processors with multiple cores, or any combination thereof.

The memory 506 may include a main memory 532, a static memory 516, and a storage unit 518 including a machine storage medium 534, accessible to the hardware processors 504 such as via the bus 510. The main memory 532, the static memory 516, and the storage unit 518 store the instructions 502 embodying any one or more of the methodologies or functions described herein. The instructions 502 may also reside, completely or partially, within the main memory 532, within the static memory 516, within the storage unit 518, within at least one of the hardware processors 504 (e.g., within the processor's cache memory), or any suitable combination thereof, during execution thereof by the machine 500.

The input/output (I/O) components 508 include components to receive input, provide output, produce output, transmit information, exchange information, capture measurements, and so on. The specific I/O components 508 that are included in a particular machine 500 will depend on the type of machine. For example, portable machines such as mobile phones will likely include a touch input device or other such input mechanisms, while a headless server machine will likely not include such a touch input device. It will be appreciated that the I/O components 508 may include many other components that are not shown in FIG. 5. The I/O components 508 are grouped according to functionality merely for simplifying the following discussion and the grouping is in no way limiting. In various examples, the I/O components 508 may include output components 520 and input components 522. The output components 520 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 522 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 508 may include communication components 524 operable to couple the machine 500 to a network 536 or devices 526 via a coupling 530 and a coupling 528, respectively. For example, the communication components 524 may include a network interface component or another suitable device to interface with the network 536. In further examples, the communication components 524 may include wired communication components, wireless communication components, cellular communication components, and other communication components to provide communication via other modalities. The devices 526 may be another machine or any of a wide variety of peripheral devices (e.g., a peripheral device coupled via a universal serial bus (USB)). For example, as noted above, the machine 500 may correspond to any one of the compute service manager 104, the execution platform 110, and the devices 526 may include the data storage device 226 or any other computing device described herein as being in communication with the data platform 102 or the data storage system 106.

The various memories (e.g., 506, 516, 532, and/or memory of the processor(s) 504 and/or the storage unit 518) may store one or more sets of instructions 502 and data structures (e.g., software) embodying or utilized by any one or more of the methodologies or functions described herein. These instructions 502, when executed by the processor(s) 504, cause various operations to implement the disclosed examples.

Described implementations of the subject matter can include one or more features, alone or in combination as illustrated below by way of example:

Example 1 is a machine-implemented method for optimizing resource allocation in a distributed data processing environment, comprising: collecting memory usage data for a function during execution of the function; determining memory constraints of the function during execution using a configurable statistical method and the memory usage data; dynamically adjusting a memory limit for the function based on the memory constraints; and scheduling a job including the function using the memory limit without user intervention.

In Example 2, the subject matter of Example 1 includes, wherein the memory usage data includes at least one of: maximum memory consumption, average memory consumption, and memory usage patterns over time.

In Example 3, the subject matter of any of Examples 1-2 includes, wherein the configurable statistical method includes at least one of: percentile calculation, moving average, exponential smoothing, or machine learning-based prediction.

In Example 4, the subject matter of any of Examples 1-3 includes, wherein dynamically adjusting the memory limit comprises raising the memory limit to a configurable percentage of a total instance memory, the percentage determined based on system performance and resource availability.

In Example 5, the subject matter of any of Examples 1-4 includes, selectively terminating one or more jobs to free resources when a node of the distributed data processing environment is under memory pressure.

In Example 6, the subject matter of any of Examples 1-5 includes, wherein scheduling the job comprises determining job placement and resource allocation decisions using the memory limit.

In Example 7, the subject matter of any of Examples 1-6 includes, dynamically adjusting a query execution plan for the job based on the memory limit and the current memory conditions of the distributed data processing platform.

In Example 8, the subject matter of any of Examples 1-7 includes, adaptively scaling resources based on predicted memory needs derived from a workload pattern analysis.

In Example 9, the subject matter of any of Examples 1-8 includes, wherein applying the configurable statistical method comprises determining a function-level memory profile by assigning memory usage into different categories for optimizing memory allocation.

In Example 10, the subject matter of any of Examples 1-9 includes, wherein scheduling the job comprises distributing two or more jobs across multiple nodes of the distributed data processing environment based on the memory limit.

Example 11 is at least one machine-readable medium including instructions that, when executed by processing circuitry, cause the processing circuitry to perform operations to implement any of Examples 1-10.

Example 12 is an apparatus comprising means to implement any of Examples 1-10.

Example 13 is a system to implement any of Examples 1-10.

Example 14 is a method to implement any of Examples 1-10.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 536 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 536 or a portion of the network 536 may include a wireless or cellular network, and the coupling 530 may be a Code Division Multiple Access (CDMA) connection, a Global System for Mobile communications (GSM) connection, or another type of cellular or wireless coupling. In this example, the coupling 530 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 502 may be transmitted or received over the network 536 using a transmission medium via a network interface device (e.g., a network interface component included in the communication components 524) and utilizing any one of a number of well-known transfer protocols (e.g., hypertext transfer protocol (HTTP)). Similarly, the instructions 502 may be transmitted or received using a transmission medium via the coupling 528 (e.g., a peer-to-peer coupling) to the devices 526. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 502 for execution by the machine 500, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methodologies disclosed herein may be performed by one or more processors. The performance of certain of the operations may be distributed among the one or more processors, not only residing within a single machine, but also deployed across a number of machines. In some examples, the processor or processors may be located in a single location (e.g., within a home environment, an office environment, or a server farm), while in other examples the processors may be distributed across a number of locations.

Described implementations of the subject matter can include one or more features, alone or in combination as illustrated below by way of example.
< >

Although the examples of the present disclosure have been described with reference to specific examples, it will be evident that various modifications and changes may be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter may be practiced. The examples illustrated are described in sufficient detail to enable those skilled in the art to practice the teachings disclosed herein. Other examples may be used and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Such examples of the inventive subject matter may be referred to herein, individually and/or collectively, by the term “example” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art, upon reviewing the above description.

What is claimed is:

1. A machine-implemented method, comprising:
collecting memory usage data for a function during execution of the function;
determining memory constraints of the function during execution using a configurable statistical method and the memory usage data;
dynamically adjusting a memory limit for the function based on the memory constraints; and
scheduling a job including the function using the memory limit without user intervention.

2. The machine-implemented method of claim 1, wherein the memory usage data includes at least one of: maximum memory consumption, average memory consumption, and memory usage patterns over time.

3. The machine-implemented method of claim 1, wherein the configurable statistical method includes at least one of: percentile calculation, moving average, exponential smoothing, or machine learning-based prediction.

4. The machine-implemented method of claim 1,
wherein dynamically adjusting the memory limit comprises raising the memory limit to a configurable percentage of a total instance memory, the percentage determined based on system performance and resource availability.

5. The machine-implemented method of claim 1, further comprising selectively terminating one or more jobs to free resources when a node of a data platform is under memory pressure.

6. The machine-implemented method of claim 1, wherein scheduling the job comprises determining job placement and resource allocation decisions using the memory limit.

7. The machine-implemented method of claim 1, further comprising dynamically adjusting a query execution plan for the job based on the memory limit and a current memory condition.

8. The machine-implemented method of claim 1, further comprising adaptively scaling resources based on predicted memory needs derived from a workload pattern analysis.

9. The machine-implemented method of claim 1, wherein applying the configurable statistical method comprises determining a function-level memory profile by assigning memory usage into different categories for improving memory allocation.

10. The machine-implemented method of claim 1, wherein scheduling the job comprises distributing two or more jobs across multiple nodes of a data platform based on the memory limit.

11. A system comprising:
at least one processor; and
at least one memory storing instructions that, when executed by the at least one processor, cause the system to perform operations comprising:
collecting memory usage data for a function during execution of the function;
determining memory constraints of the function during execution using a configurable statistical method and the memory usage data;
dynamically adjusting a memory limit for the function based on the memory constraints; and
scheduling a job including the function using the memory limit without user intervention.

12. The system of claim 11, wherein the memory usage data includes at least one of: maximum memory consumption, average memory consumption, and memory usage patterns over time.

13. The system of claim 11, wherein the configurable statistical method includes at least one of: percentile calculation, moving average, exponential smoothing, or machine learning-based prediction.

14. The system of claim 11,
wherein dynamically adjusting the memory limit comprises raising the memory limit to a configurable percentage of a total instance memory, the percentage determined based on system performance and resource availability.

15. The system of claim 11, wherein the operations further comprise selectively terminating one or more jobs to free resources when a node of a data platform is under memory pressure.

16. The system of claim 11, wherein scheduling the job comprises determining job placement and resource allocation decisions using the memory limit.

17. The system of claim 11, wherein the operations further comprise dynamically adjusting a query execution plan for the job based on the memory limit and a current memory condition of the distributed data processing platform.

18. The system of claim 11, wherein the operations further comprise adaptively scaling resources based on predicted memory needs derived from a workload pattern analysis.

19. The system of claim 11, wherein applying the configurable statistical method comprises determining a function-level memory profile by assigning memory usage into different categories for improving memory allocation.

20. The system of claim 11, wherein scheduling the job comprises distributing two or more jobs across multiple nodes of a data platform based on the memory limit.

21. A machine-storage medium storing instructions that, when executed by one or more processors of a system, cause the system to perform operations comprising:
collecting memory usage data for a function during execution of the function;
determining memory constraints of the function during execution using a configurable statistical method and the memory usage data;
dynamically adjusting a memory limit for the function based on the memory constraints; and
scheduling a job including the function using the memory limit without user intervention.

22. The machine-storage medium of claim 21, wherein the memory usage data includes at least one of: maximum memory consumption, average memory consumption, and memory usage patterns over time.

23. The machine-storage medium of claim 21, wherein the configurable statistical method includes at least one of: percentile calculation, moving average, exponential smoothing, or machine learning-based prediction.

24. The machine-storage medium of claim 21,
wherein dynamically adjusting the memory limit comprises raising the memory limit to a configurable percentage of a total instance memory, the percentage determined based on system performance and resource availability.

25. The machine-storage medium of claim 21, wherein the operations further comprise selectively terminating one or more jobs to free resources when a node of a data platform is under memory pressure.

26. The machine-storage medium of claim 21, wherein scheduling the job comprises determining job placement and resource allocation decisions using the memory limit.

27. The machine-storage medium of claim 21, wherein the operations further comprise dynamically adjusting a query execution plan for the job based on the memory limit and a current memory condition.

28. The machine-storage medium of claim 21, wherein the operations further comprise adaptively scaling resources based on predicted memory needs derived from a workload pattern analysis.

29. The machine-storage medium of claim 21, wherein applying the configurable statistical method comprises determining a function-level memory profile by assigning memory usage into different categories for improving memory allocation.

30. The machine-storage medium of claim 21, wherein scheduling the job comprises distributing two or more jobs across multiple nodes of a data platform environment based on the memory limit.
